(19) United States
(12) Patent Application Publication
(10) Pub. No.: US 2020/0271684 A1
(43) Pub. Date: Aug. 27, 2020

(54) Method of Detection and Measurement of a Life Force Energy, Also Known as KELEA, in Liquids & Other Materials

(71) Applicant: William John Martin, South Pasadena, CA (US)

(72) Inventor: William John Martin, South Pasadena, CA (US)

(21) Appl. No.: 16/288,005

(22) Filed: Feb. 27, 2019

(51) Int. Cl. G01N 37/00; G01N 1/38; G01N 27/22

(52) U.S. Cl. CPC G01N 37/005; G01N 1/38; G01N 27/221; D21H 11/12; G01N 2223/101; G01N 2223/03; G01N 2223/637; G01N 2001/386

(57) ABSTRACT

The weight of cellulose containing materials, including paper, cardboard, cotton fabrics and unprocessed wood will increase significantly when exposed to a novel form of energy, which the inventor has termed KELEA (kinetic energy limiting electrostatic attraction). This energy is comparable to what is commonly termed a universal life force in traditional Chinese medicine and what is also attributed to the beneficial health effects of certain naturally occurring and processed drinking water. These waters are sometime referred to as being energized, activated, micro-clustered, etc. The present invention describes a way to quantitatively assess the KELEA emitting activity of these beneficial waters, as well as other fluids, including gasoline and diesel fuels. The fluids can be monitored, even when contained in a sealed container, such as a mini-hot water bag.

### RELATED PUBLICATION BY THE APPLICANT

1. Martin, W. J. (2003) Stealth Virus Culture Pigments, A Potential Source of Cellular Energy. Experimental Molecular Pathology, 74, 210-223.
2. Martin, W. J. (2005) Alternative Cellular Energy Pigments from Bacteria of Stealth Virus Infected Individuals. Experimental Molecular Pathology, 78, 217-217.
3. Martin W J (2014). Stealth Adapted Viruses; Alternative Cellular Energy (ACE) & KELEA Activated Water. Author House, IN. pp 321. ISBN 978-1-4969-0496-6.
4. Martin, W. J. (2014) KELEA Activated Water—Enhancing the Alternative Cellular Energy (ACE) Pathway. In Stealth Adapted Viruses; Alternative Cellular Energy (ACE) & KELEA Activated Water. Author House, Bloomington, Ind., USA, pp. 115-144.
5. Martin, W. J. (2014) KELEA Activated Water Leading to Improved Quantity & Quality of Agricultural Crops. Advances in Plants & Agriculture Research, 2, 00033.
6. Martin, W. J. (2015) Therapeutic Potential of KELEA Activated Water. International J of Complementary & Alternative Medicine, 1(1), 00001.
7. Martin, W. J. (2015) Alternative Cellular Energy Pathway Therapy Using KELEA Activated Water. International J Complementary & Alternative Medicine, 2(2), 00051.
8. Martin, W. J. (2015) KELEA, A Natural Energy That Seemingly Reduces Intermolecular Hydrogen Bonding in Water and Other liquids. Open Journal of Biophysics, 5, 69-79.
9. Martin, W. J. and Laurent, D. (2015) Homeopathy as A Misnomer for Activation of the Alternative Cellular Energy Pathway, Evidence for the Therapeutic Benefits of Enercel in a Diverse Range of Clinical Illnesses. International J Complementary & Alternative Medicine, 2(1), 00045
10. Martin, W. J. (2015) Interacting Light Paths Attract KELEA (Kinetic Energy Limiting Electrostatic Attraction) and Can Lead to the Activation of Water. Open Journal of Biophysics, 5, 115-121.
11. Martin, W. J. (2015) Interactive Electric Fields Can Attract KELEA (Kinetic Energy Limiting Electrostatic Attraction) and Can Lead to the Activation of Water. International J Complementary & Alternative Medicine, 1(6), 00034.
12. Martin, W. J. (2016) KELEA (Kinetic Energy Limiting Electrostatic Attraction) May Add to the Measured Weight of an Object. J Modern Physics, 7(6), 461-472.
13. Martin, W. J. (2016) KELEA (Kinetic Energy Limiting Electrostatic Attraction) Offers an Alternative Explanation to Existing Concepts Regarding Wave-Particle Duality, Cold Fusion and Superconductivity. J Modern Physics, 7(15), 1995-2007
14. Martin, W. J. (2016) Preparing and Using KELEA Activated Water to Enhance the Alternative Cellular Energy (ACE) Pathway in the Therapy of Multiple Illnesses. International J Complementary & Alternative Medicine, 3(1), 00059.
15. Martin, W. J. (2015) KELEA Activation of Water and Other Fluids for Health, Agriculture and Industry. Journal of Water Resource and Protection, 7, 1331-1344.
16. Martin, W. J. (2016) KELEA, Cosmic Rays, Cloud Formation and Electromagnetic Radiation, Electropollution as a Possible Explanation for Climate Change. Atmospheric and Climate Sciences, 6(2), 174-179.
17. Martin, W. J. (2016) Cancer as an Insufficiency of Cellular Energy (ICE), Therapeutic Approaches Based on Enhancing the Alternative Cellular Energy (ACE) Pathway. International J Complementary & Alternative Medicine, 3(3), 00074.
18. Martin, W. J. (2016) Insufficiency of Cellular Energy (ICE) in Neurons, From Electrical Hyperactivity to Quiescence. International Journal Complementary Alternative Medicine, 4, 00118.
19. Martin, W. J. (2016) Insufficiency of Cellular Energy (ICE) May Precede Neurodegeneration in Alzheimer's Disease and Be Treatable via the Alternative Cellular Energy (ACE) Pathway. Advances in Alzheimer's Disease, 6(1), 1-12.
20. Martin, W. J. (2016) Insufficiency of Cellular Energy (ICE), The Basis for Many Illnesses Potentially Correctable Using KELEA Activated Water. International J Complementary & Alternative Medicine, 4(1), 00106.
21. Martin, W. J. (2017) Cancer Is Treatable via the Alternative Cellular Energy (ACE) Pathway, Journal of Cancer Therapy, 8, 1279-1290
22. Martin, W. J. (2017) Using KELEA (Kinetic Energy Limiting Electrostatic Attraction) to Improve the Efficiency of Fuel Combustion. Open Journal Air Pollution, 6(3), 103-116.
23. Martin, W. J. (2017) Is KELEA (Kinetic Energy Limiting Electrostatic Attraction) a Source of Chemical Energy? MOJ Biorg Org Chem, 1(2), 54-58.
24. Martin, W. J. (2017) Insufficiency of Cellular Energy (ICE) from the Alternative Cellular Energy (ACE) Pathway Limiting the Specialized Functions of Neuronal Cells. International J Complementary & Alternative Medicine, 4(2), 00112.
25. Martin, W. J. (2017) Hyper-Excitability Followed by Functional Quiescence in Neuronal Cells Caused by Insufficient Cellular Energy (ICE), Treatable by Enhancing the Alternative Cellular Energy (ACE) Pathway. World Journal of Neuroscience, 7(3), 257-266.
26. Martin, W. J. (2017) Tissue Regeneration without Scarring Achieved by Enhancing the Alternative Cellular Energy (ACE) Pathway. Journal of Cosmetics, Dermatological Sciences and Applications, 7(1), 82-98.
27. Martin W J (2018) Is the placebo effect mediated by the Alternative Cellular Energy (ACE) pathway? International J Complementary & Alternative Medicine, 11(4): 231-233.
28. Martin W J (2018) KELEA Activated Water as an Alternative to Stem Cell Injections in Regenerative Medicine. International J Complementary & Alternative Medicine, 11(5), 251-258.
29. Martin W J (2019) Electromagnetic Radiation Causes Weight Loss and Weight Destabilization of Objects with Presumed Elevated Levels of KELEA (Kinetic Energy Limiting Electrostatic Attraction), Relevance to Human Health and to Global Warming. Modern J Physics (in press)

### RELATED PATENT APPLICATIONS BY THE APPLICANT

ACE-pigments and Humic acid as energy sources. Application Ser. No. 10/192,936 Method of assessing and of activating the alternative cellular energy (ACE) pathway in the therapy of diseases. William John Martin Submitted Jan. 16, 2008. Application Ser. No. 12/009,195

Enerceutical mediated activation of the alternative cellular energy (ACE) pathway in the therapy of diseases. Application Ser. No. 12/151,779

Regenerative wound healing using copper-silver citrate composition. Application Ser. No. 12/288,749

Enerceutical activation of the alternative cellular energy (ACE) pathway in therapy of diseases. Application Ser. No. 12/069,597

Method of using the body's alternative cellular energy pigments (ACE-pigments) in the therapy of diseases application Ser. No. 12/378,934

Urine as a source of alternative cellular energy pigments (ACE-pigments) in the assessment and therapy of diseases. Application Ser. No. 12/381,003

Activation of the alternative cellular energy (ACE) pathway in the therapy of diseases. Application Ser. No. 12/802,605

Methods for the detection of alternative cellular energy (ACE) pigments and for monitoring of the ACE pathway in the diagnosis and therapy of diseases. Application Ser. No. 12/802,763

Diagnostic value of systemic ACE pathway activation in the detection by fluorescence of localized pathological lesions. Application Ser. No. 12/804,619

Enerceutical mediated activation of the alternative cellular energy (ACE) pathway in the therapy of diseases. Application Ser. No. 12/151,779

Energy Charged Liquids to Enhance Enerceutical Activation of the Alternative Cellular Energy (ACE) Pathway in the Therapy of Diseases. Application Ser. No. 12/972,344

Energy Charged Alcoholic Beverages for Enhancing the Alternative Cellular Energy Pathway in the Prevention and Therapy of Diseases. Application Ser. No. 12/984,582

Energy Charged Liquids to Enhance Enerceutical Activation of the Alternative Cellular Energy (ACE) Pathway in the Therapy of Diseases application Ser. No. 12/972,344

Methods for Detecting and Monitoring the Activity of Energized Water and Other Liquids Useful for Enhancing the Alternative Cellular Energy Pathway in the Prevention and Therapy of Diseases. Application Ser. No. 13/016,948

Methods for Increasing the Kinetic Activity of Alcohol, Water and Other Liquids, so as to Render the Liquids More Useful in Enhancing the Alternative Cellular Energy Pathway in the Prevention and Therapy of Diseases. Application Ser. No. 13/029,116

Methods for Increasing the Kinetic Activity of Alcohol, Water and Other Liquids, so as to Render the Liquids More Capable of Enhancing the Alternative Cellular Energy Pathway in the Prevention and Therapy of Diseases application Ser. No. 13/040,262

Methods for Increasing the Kinetic Activity of Water and Other Liquids, so as to Render the Liquids More Useful in Enhancing the Alternative Cellular Energy Pathway and in Various Other Agricultural and Industrial Applications. Application Ser. No. 13/166,800

Use of Plants Extracts to Activate Water, Alcohol and Other Liquids. Submitted Oct. 27, 2011. Application Ser. No. 13/272,215.

Methods of Transferring Energies to Water, Alcohols and Minerals. Submitted Nov. 25, 2011. Application Ser. No. 13/304,558.

Use of Certain Foods and Dietary Supplements as Water and Beverage Activating Enerceuticals. Application Ser. No. 14/507,822

Heat as a Method to Enhance the Fluid Activating Ability of Humic Acids, Zeolites and related Enerceuticals. Application Ser. No. 14/294,076

Method of Enhancing the Alternative Cellular Energy Pathway in Humans and Animals Using Wearable Items That Contain KELEA Activated Water. Submitted Feb. 18, 2019. application Ser. No. 16/278,712

### STATEMENT REGARDING FEDERALLY SPONSORED RESEARCH OR DEVELOPMENT

Not applicable: No Federal funding was received in support of this patent application.

### REFERENCE TO SEQUENCE LISTING, A TABLE OR A COMPUTER PROGRAM LISTING COMPACT DISK APPENDIX

Not Applicable

### FIELD OF THE INVENTION

The invention is within the field of a form of energy, which has major health, agriculture and industrial applications. The energy is referred to by the Applicant as KELEA, being an abbreviation for kinetic energy limiting electrostatic attraction. The energy is commonly discussed in traditional Chinese medicine as the universal life force. It is also implied that some types of “energized” water can transmit this energy when it is consumed by humans and/or when used in agriculture. The present invention is primarily focused on a convenient method to detect and to measure this energy, especially when coming from closed containers of fluids. By describing an easily procedure for measuring this energy, the present discovery will greatly facilitate the effective clinical, agricultural and industrial uses of the energy. Background information pertaining to the present invention is embodied in the above cited publications and multiple submitted patent applications, which are incorporated herein by reference.

### BRIEF SUMMARY OF THE INVENTION

It was discovered that weight of cellulose containing materials, including regular sheets of paper, cotton fabrics, and pieces of unprocessed wood, will increase if they are stored close to containers of KELEA activated water. Moreover, the weight of the KELEA exposed items will gradually return to the initial weight during the continuing weighing of the items in an electronic balance. The increase in weight is attributed to the absorption of KELEA by the separated electrical charges on cellulose molecules, especially in the shorter, branched, interlocking form present in paper. The added energy can be subsequently stripped from the cellulose materials by the electromagnetic radiation generated by the electronic balance, or by other devices. The levels of the reversible weight increase by a single rolled sheet of regular typing paper placed onto or near to a closed mini-hot water bag containing water is being used to detect and to quantify the level of KELEA in the water. The Applicant envisions that this assay will greatly facilitate the widespread, reliable use of the mini-hot water bags as a wearable Waterceutical™ by many individuals. The assay system will also be applied to the many other applications for which KELEA activated fluids can be used. Furthermore, the basic assay is also of considerable use in assessing the initial level and longevity of KELEA activation of various fluids.

### BRIEF DESCRIPTION OF THE DRAWINGS

Not Applicable and none included

### DETAILED DESCRIPTION OF THE INVENTION

In a series of publications and patent applications, the Applicant has provided evidence for a source of cellular energy in humans, animals and plants, which is different from that provided by calories in food. The additional cellular energy has been described as the alternative cellular energy (ACE) pathway. A natural force, which the Applicant refers to as KELEA (kinetic energy limiting electrostatic attraction), adds a dynamic or kinetic quality to the fluids of living organisms and can significantly enhance the overall wellbeing of humans. This added dynamic or kinetic energy can be converted to chemical energy in support of cellular functions and may also directly participate in maintaining the normal electrical activities of cells. Humans mainly obtain KELEA via the fluctuating electrical activities of the brain and probably muscles, including the heart. It can also be obtained from the consumption, inhalation, skin application, or even being in close proximity of KELEA activated water.

The fundamental role of KELEA is proposed to be that of preventing the fusion and presumed annihilation of electrostatically juxtaposed opposite electrical charges. It can do so by imposing a repulsive barrier between the opposing charges. The same energy in fluids can lead to a loosening of the intermolecular electrostatic hydrogen bonding and an increase in volatility and in the internal movements within the fluids. The effect is also seen as a reduction in surface tension of the fluid. The Applicant has devised various assays to reliably measure these changes in water, ethanol and other fluids. Specifically, the volatility of water can be measured as weight loss in closed but not completely sealed containers. Surface tension and internal movements can be monitored by sprinkling fine particles of neutral fed onto the surface of water. In static water, these particles stay on the surface of the water and slowing dissolve into expanding flat, filled red colored circles around the particles. In more activated water, the particles pass below the surface and can move in a sideways linear, back and forth manner. The particles tend to aggregate into a small cluster, from which individual particles are repulsed, only to return back towards the cluster.

The Applicant has recently discovered a reliable method of assessing the levels of transmission of KELEA from KELEA activated fluids, even when the fluids are confined within a closed container. The basis of the method is more fully described in an article by the inventor to be published soon in the Journal of Modern Physics. The article is entitled “Electromagnetic Radiation Causes Weight Loss and Weight Destabilization of Objects with Presumed Elevated Levels of KELEA (Kinetic Energy Limiting Electrostatic Attraction), Relevance to Human Health and to Global Warming.”

As described in the above article, a regular sheet of typing paper, which is rolled into an 8″ diameter cylinder for ease of weighing, will typically weigh approximately 4.5 grams. This weight will increase, usually in excess of 4.5 milligrams, when the sheet of paper is placed for an hour or somewhat longer period, adjacent to a container of water with a high level of KELEA activation, Most of the gain in weight will be slowly lost as the paper is being reweighed in an electronic balance. The additional weight can be regained by again positioning the rolled sheet of paper adjacent to the container of KELEA activated water. No meaningful increase in weight is seen if the mini-hot water bag has regular water.

Numerous variations of this basic system have confirmed the underlying observation that activated fluids can emit an energy, which can cause a measurable weight increase in paper and in certain other materials; and that this added weight will be lost when the materials are continually weighed in an electronic balance. These variations have led to the following conclusions. i) The loss of weight occurring during the continuing weighing of a KELEA weight enhanced object is attributed to the electromagnetic field created by the balance. Similar weight losses can be achieved using other sources of electromagnetic radiation, including the speakers from a turned-on radio (without the sound being necessary), an active cell phone, a television set, and 120 volt electrical wiring. ii) As a routine, I now customarily strip any previously added excess KELEA on the selected rolled sheet of paper for testing by exposing the paper to electromagnetic radiation before using it to detect the possible emission of KELEA from a contained sample of water. This allows for the repeated use of same sheet of paper for direct comparisons between different water samples. iii) The effects are seen to a somewhat lesser extent using other cellulose products, including cardboard, cotton fabrics and unprocessed wood. It can also occur to some extent with other KELEA attracting materials, such as humic and fluvic acids, zeolites, mineral oxides, etc. In practice, the use of sheets of typing paper provides better standardization than the use of alternative materials. iv) The assay can be reversed by enclosing a rolled sheet of paper in a closed Ziploc bag and spraying the outside of the bag with the fluid being tested for its KELEA transmitting capacity. Similarly, the Ziploc bag with the rolled sheet of paper can be floated onto water to be tested. v) Fluids other than water can be tested and, in particular ethanol, gasoline and diesel fuels. vi) The assay can be applied to detect the emission of KELEA from other sources, such as oscillating electrical devices; natural products, including living plants; humans, etc. vii) The assay can also be used to monitor KELEA reducing environments, as assessed by the reduction in weight of a KELEA weight-enhanced sheet of paper by being placed into the environment being monitored.

The most immediate application of the invention is to monitor the continuing activity of the fluid placed into mini-hot water bags (bottles). These bags are being evaluated as a wearable Waterceutical™, including the placing of the bags within the socks at the ankle. This placement has the advantage of repetitive agitation (movement) of the fluid during walking.

KELEA activated water in mini-hot water bags have also been attached to various locations, including hot water heater, household water supply, etc. A very important application with initial signs of efficacy is the placement of the mini-hot water bags on the sides of a gasoline fuel tank, as a means of imparting chemical energy to the gasoline.

To avoid the loss of activity due to the increased volatility of KELEA activated water, the screw-in closures of the bottles can be permanently sealed using products such as Christy's Red Hot Blue Glue (a PVC pipe cement) or Rectorseal EP-200 Epoxy Putty. A major advantage of the current invention is the ability to repeatedly assess the continuing activity of the sealed bags and other closed containers. This is now being performed on some mini-hot water bags on a weekly basis, with surprising good results.

Larger containers are envisioned for major industrial applications, such as in power plants, large diesel engines, municipal water supply, etc. In some stationary locations, the activity may cease from inactivity. Using a sheet of paper near such a bag can potentially be used to monitor on-site for remaining activity. Possibly, any lost activity could be restored by jolting the container, being equivalent to what is referred to as succession in homeopathy. The assay will allow for the testing of the effectiveness of these types of procedures.

Another current use is to determine if various additions to KELEA activated water can either increase or prolong the KELEA transmitting capacity. Various dipolar compounds are being evaluated in this regard. The addition of neutral red dye in conjunction with ultraviolet light is also being considered as a testable way of increasing the level of emitted KELEA as assessed by the described assay, or modifications of the assay

The invention now being described, it will be apparent to one of skill in the art that the findings are reflective of an entirely new paradigm of almost unlimited possibilities. It will also spur new discoveries into the physics of KELEA. Modifications and extensions of the topics included in this application will undoubtedly follow without departing from the spirit and scope of the discoveries.

1. A method of detecting a type of life force energy, which the Applicant refers to as KELEA, being an abbreviation for kinetic energy limiting electrostatic attraction, based upon the finding that cellulose containing and certain other materials will undergo an increase in their weight when closely exposed to a heightened level of KELEA, and that this increase in weight is reversed when the materials are subsequently exposed to a heightened level of electromagnetic radiation, such as is present in an electronic balance; this system, thereby, comprising an assay system for KELEA.

2. The method of claim 1 in which the cellulose material is paper, including regular typing paper.

3. The method of claim 1 in which the cellulose material is chosen from cardboard, cotton fabric, or wood.

4. The method of claim 1 in which the other materials refer to products including humic and fluvic acids, zeolites and mineral oxides.

5. The method of claim 1 in which the heightened level of KELEA is provided by KELEA activated water in a closed container.

6. The method of claim 1 in which the cellulose containing, KELEA detection material, such as a rolled sheet of regular typing paper is enclosed in a container, such as a Ziploc bag, with the fluid to be tested for KELEA transmitting capacity is placed outside of the container.

7. The method of claim 1 in which the fluid to be tested has been placed into a closed mini-hot water bag (bottle) that can be tested at various locations by placing a pre-weighed sheet of paper near to the bag and subsequently assessing the sheet of paper for an increase in weight that can be reversed by electromagnetic radiation.

8. The method of claim 1 in which the fluid to be tested for its KELEA emission activity is a combustible fuel, such as gasoline or diesel

9. The method of claim 1 in which the container is designed for large scale industrial uses, such as in power plants, large diesel engines, and municipal water supply.

10. The method of claim 1 in which the assay is used to monitor the overall environmental level of natural or induced KELEA, including the transmission of KELEA from natural products, including plants, animals and humans.

11. The method of claim 1 in which the assay is used to monitor the KELEA withdrawing ability of certain environments as assessed by a reversal of the KELEA induced increased weight of an object that is placed into the environment to be monitored.
